(19) United States
(12) Patent Application Publication
(10) Pub. No.: US 2025/0036538 A1
(43) Pub. Date: Jan. 30, 2025

(54) APPARATUSES AND METHODS FOR ENABLING ACTIONABLE ANALYSIS OF SUPPORT REQUESTS

(71) Applicant: Purdue Research Foundation, West Lafayette, IN (US)

(72) Inventor: Sarah Nicole Rodenbeck, Whitestown, IN (US)

(21) Appl. No.: 18/782,020

(22) Filed: Jul. 23, 2024

Related U.S. Application Data
(60) Provisional application No. 63/528,516, filed on Jul. 24, 2023.

(51) Int. Cl. G06F 11/30

(52) U.S. Cl. CPC G06F 11/3072; G06F 11/3086

(57) ABSTRACT

Systems and methods for enabling actionable analysis of support requests are disclosed. Embodiments include systems and methods that ingest support ticket data into an automated workflow (for example, a cron orchestrator), which interacts with one or more databases, one or more APIs, and one or more UIs to supply a user with actionable analysis for, e.g., assisting customers with complex issues. Embodiments may also include one or more ingestion deployments, pre-processing models, pattern-based filtering models, embedding models, message relevancy filtering models, clustering models, anomaly detection models, forecasting models and/or database ingestion models.

This application claims the benefit of U.S. Provisional Application No. 63/528,516, filed 24 Jul. 2023, the entirety of which is hereby incorporated herein by reference.

### FIELD

Embodiments of this disclosure relate generally to a computer support systems and methods, and to systems and methods for assisting computer support agents in providing help to customers.

### BACKGROUND

Customers utilizing computational resources can require assistance to accomplish their goals in using the computational resources. When requesting assistance, a help ticket is frequently generated, and the help ticket is used to record information associated with the customer support that was provided. Information recorded in the help ticket can include, for example, the time and date of the request, broad information related to the nature of the request, numerous messages between the customer and the computing center agent (which frequently include pleasantries between the customer and the agent), information identifying the customer requesting assistance, information identifying the customer requesting assistance and the computing center agent (also referred to as computing center support staff) who addressed the issue, detailed information about the specific issue (which may include multiple messages between the customer and the agent), and the time and date of when the request was resolved.

Example computational resources include those used by business and/or universities, including the information technology (IT) departments and any computing resources associated therewith. These computational resource centers frequently handle large numbers of support requests. Moreover, the customers accessing the computational recourses can be highly skilled themselves, such as in the university setting the customers can be professors and students accessing the computational resources for analytical and/or research purposes. For example, the scientific applications team at Purdue University's Rosen Center for Advanced Computing (RCAC), which provides advanced computational resources and services to support Purdue University faculty and staff researchers, handles hundreds of support requests every month.

When the assistance required by the customer relates to relatively simple issues (e.g., password help or help accessing (logging into) the computational resource system), the assistance can be given by agents with a minimal amount of skill with the computational resources. However, when the assistance required by the customer relates to more complicated issues (e.g., message passing interface (MPI) issues for parallel computing), the assistance requires agents with more robust skills. Nevertheless, the nature of some issues can be sufficiently complex that even highly skilled agents at the resource center may be unable to fully address the customer's issue without requiring substantial additional work seeking additional information and/or assistance.

It was realized by the inventor of the current disclosure that problems exist with the ability of a computational resource center agents to provide customer assistance in all situations and that improvements in the ability of computing center support agents to locate meaningful and actionable information related to a customer's particular needs are needed.

### SUMMARY

The inventor of the present disclosure realized that many information technology service management (ITSM) tools focus on the process of handling support tickets themselves (e.g. creating reports of descriptive statistics only, such as the number of tickets closed) with few (if any) analytic capabilities, and that tools with more comprehensive analytic capabilities were needed, such as capabilities based on the content of the ticket and not just metadata (such as the date the ticket was opened). The inventor further realized that understanding trends in the support request data over time can support a better customer experience by, for example, identifying trends in topics, providing a more robust method for knowledge management, providing a means to identify commonly-asked questions, identify less-common questions, and training agents (especially training new advanced customer support agents). Traditional statistical methods for analyzing these data can be helpful but cannot robustly analyze text, which is typically the primary information in a help ticket.

Moreover, while the inventor of the present disclosure realized that natural language processing (NLP) techniques could be a beneficial mechanism for analyzing help ticket topics, the inventor also realized that while supervised learning may be the gold standard for many NLP tasks, NLP would suffer from several key downsides within the context of this enabling actionable analysis of support requests (e.g., help tickets). First, even if transfer learning is used, fine-tuning the pre-trained models would still require a significant amount of labelled data-on the scale of hundreds to thousands of data points per category. And, while some developments have show promising results classifying ticket data through supervised methods, these developments still required categorizing and annotating thousands of tickets to train the model.

Still further, the inventor realized that the annotation efforts required with these methods are often extremely manual, require specialized domain knowledge, and are time consuming. Additionally, the set of labels/categories required when performing these annotations efforts must be defined from the start. Furthermore, the number of computer resource and service center (CRSC) agents who answer tickets makes it difficult for any one agent to have a sufficiently complete understanding of tickets to fully define such categories. Still further, any attempts to define the categories would be rendered obsolete after a few years, especially if different versions of the computational resources are retired and/or brought online as the software evolves, such as in the context of High-Performance Computing (HPC) clusters (one example being supercomputing clusters). It is noted for the reader that the clustering models addressed in this disclosure (e.g., clustering model 260 and clustering model 340) are different from the hardware clusters (e.g., HPC hardware clusters) that are mentioned in this disclosure as one example of a type of computational resource that can be retired and/or brought online as the resource evolves.

It was also realized by the inventor that unsupervised learning can provide a possible solution to these issues. For example, unsupervised learning can shorten the model development lifecycle, such as by eliminating the data annotation step. As another example, unsupervised learning can be robust to shifts in ticket topic composition over time. Finally, unsupervised learning has the potential to more easily be applied to different data domains, which may be help ticket data from other entities (for example, in the context of a university, from other information technology (IT) teams at the same or different universities).

Embodiments of the present disclosure provide improved apparatuses and methods for enabling actionable analysis of support requests (e.g., support tickets).

Additional embodiments of the present disclosure provide improved apparatuses and methods for enabling actionable analysis of support requests using natural language processing.

Further embodiments of the present disclosure apply unsupervised learning techniques to computer resource and service center (CRSC) ticket data and provide an interactive application (e.g., a web application) for interactive and continuous delivery of insights from the data.

Still further embodiments of the present disclosure use the content of a support/help ticket (which can be combined with ticket metadata) to enable users (e.g., agents at the computational center) to, for example, obtain a bigger picture view of trends. Features and analytic capabilities of embodiments of the present disclosure enable users to analyze overall trends in support tickets.

Yet further embodiments of the present disclosure provide systems and/or methods for effectively utilizing prior interactions between customers and support center agents (e.g., past help ticket information) to obtain meaningful and actionable information to assist the agents in addressing the needs of customers utilizing the computing center's resources. The systems and/or methods can be used to assist agents in addressing varying complexities of customer needs from the simple to the highly complex.

Certain preferred features of the present disclosure address these and other needs and provide other important advantages.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 is an illustration of data system architecture for enabling actionable analysis of support requests according to at least one embodiment of the present disclosure.

FIG. 2 is diagram depicting a system for enabling actionable analysis of support center help requests according to embodiments of the present disclosure.

FIG. 3 is an illustration of a graphical user interface display of support request data metrics according to at least one embodiment of the present disclosure.

FIG. 4 is an illustration of clustering of support request data performed by at least one embodiment of the present disclosure.

FIG. 5 is an illustration of a graphical user interface display of support request ticket data clustering according to at least one embodiment of the present disclosure.

FIG. 6 is an illustration of a graphical user interface display of the numbers of support request ticket data with identifying information such as names hidden according to at least one embodiment of the present disclosure.

FIG. 7 is an illustration of a graphical user interface display of top individual customer submitters, top group submitters and longest open clusters of the analyzed support request ticket data according to embodiments of the present disclosure.

FIG. 8 is an illustration of a graphical user interface display of cluster-wise analysis and metrics depicting top groups for a cluster and anomaly detection according to embodiments of the present disclosure.

FIG. 9 is an illustration of a graphical user interface display of semantic search and filtering with identifying information such as names hidden according to at least one embodiment of the present disclosure according to embodiments of the present disclosure.

FIG. 10 is a diagrammatical view of a computational system for enabling actionable analysis of support center help requests according to one embodiment of the present disclosure.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” that may occur within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

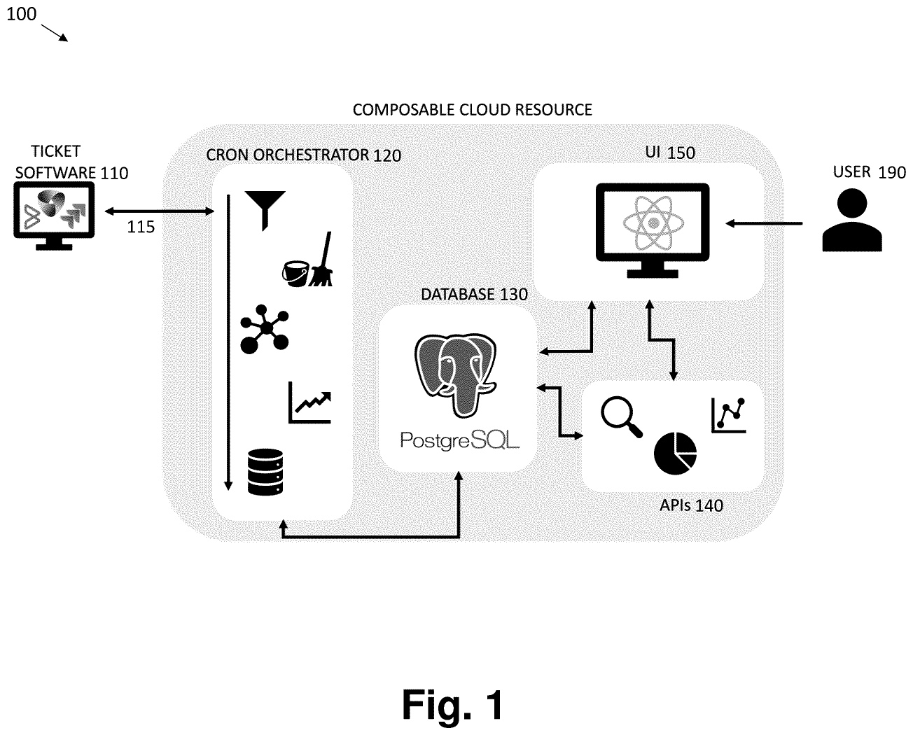

FIG. 1 shows an overview of data system architecture and infrastructure for enabling actionable analysis of support requests (which can include natural language processing) according to embodiments of the present disclosure. Depicted in FIG. 1 is a system 100, one example being the TicketHub system that has been implemented at Purdue University. System 100 includes an automated workflow 120 (which in some example embodiments is referred to as a Cron Orchestrator) that accesses ticket data from ticket software 110 and communicates with a database 130. The database 130 communicates with one or more application programming interfaces (APIs) 140, which communicate with an user interface (UI) 150 (e.g., an interface where a computational center agent can interact with the system), which displays information to and receives inputs from an agent (user 190). While the user interface 150 is depicted as being able to communicate directly with the database 130, in some embodiments this communication pathway is not allowed for security reasons. Moreover, in some embodiments a system administrator has the capability of connecting directly to the user interface 150, the application programming interfaces 140, and/or the database 130, while a user has the capability of connecting directly only to the user interface 150 and/or the application programming interfaces 140.

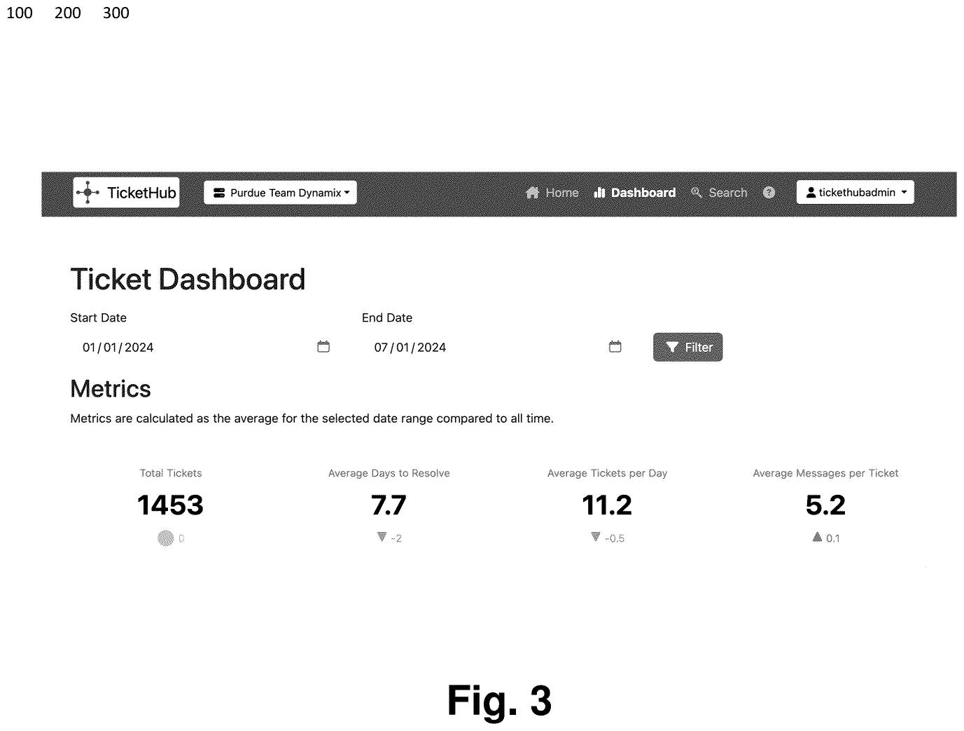

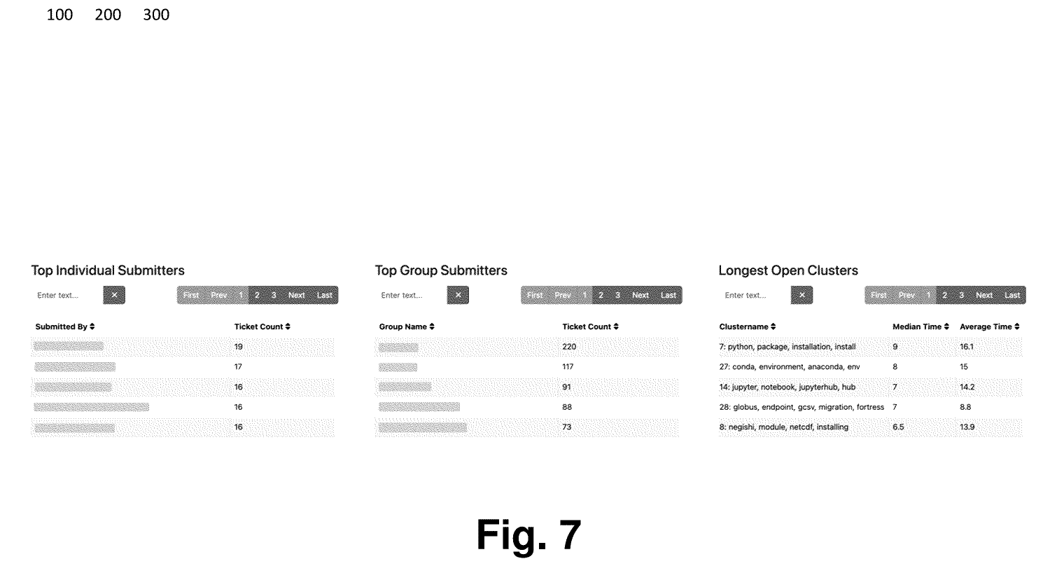

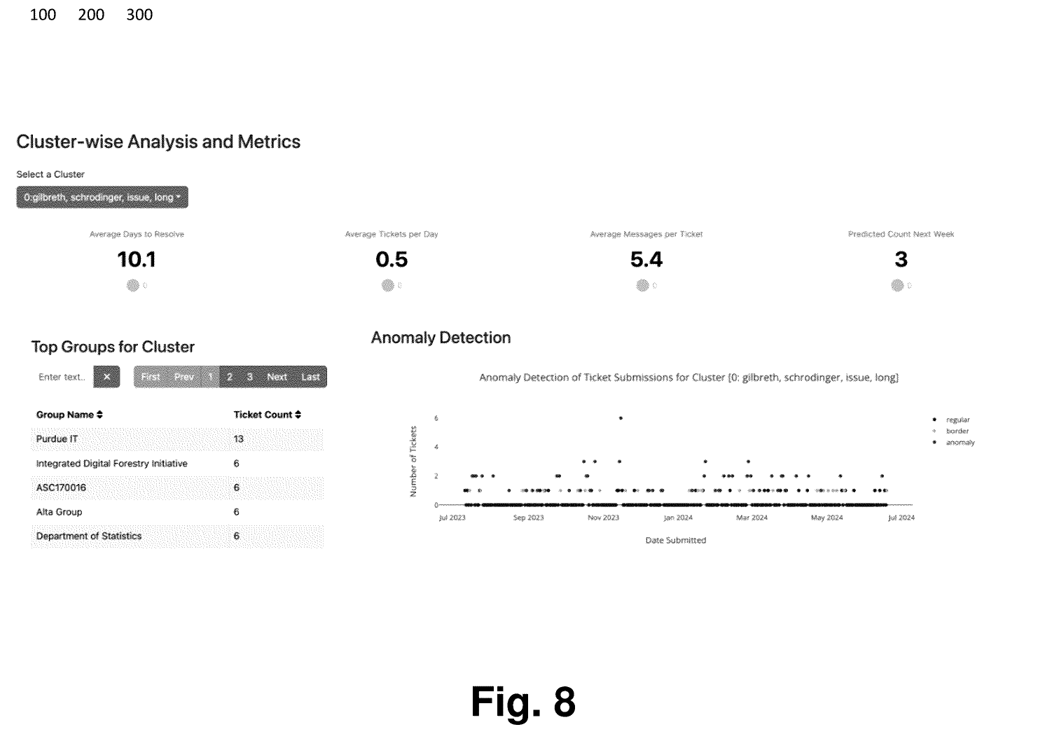

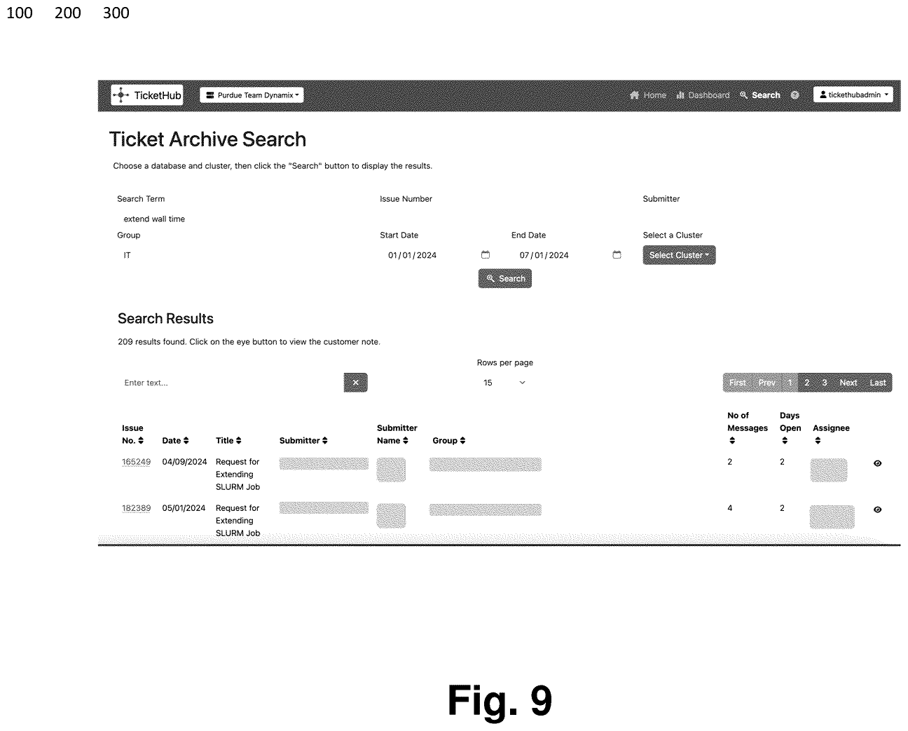

The automated workflow (e.g., Cron Orchestrator) 120 communicates with the ticket software 110 and receives input data 115 from the ticket software 110, which may include full text and limited metadata of tickets (e.g., help tickets), which are typically assigned to a computer resource and service center (CRSC). One example of a computer resource and service center (CRSC) is a university resource and service center that provides computational resources and services to university faculty, staff and/or students, such as Purdue University's Rosen Center for Advanced Computing (RCAC). The input data 115 can span small or large timeframes, and can include multiple years of ticket information. One example, which was used to generate the information displayed in FIGS. 3-9, included over 20,000 tickets comprising approximately 95,000 individual messages was processed using embodiments of the present disclosure. Each ticket can include a ticket title and text, and can also include information about when the ticket was submitted and closed as well as the customer who submitted the ticket. Tickets are typically sourced from one or more ticketing systems used at one or more computer resource and service centers (CRSCs), and each ticketing system may have one or more databases storing the ticketing information. Example ticketing systems where ticketing information may be obtained include the Footprints (FP), Jira and TeamDynamix ticketing systems at Purdue University's Rosen Center for Advanced Computing (RCAC). In situations where there is an inability to directly gain access to the underlying ticketing system database, a database can be created to hold the data, which may also include model results and supporting information. In one example embodiment a PostgreSQL database can be created to hold the data, as well as the model results and supporting information.

Embodiments of the present disclosure include one or more of the following deployments: a database 130, which may be hosted (e.g., a PostgreSQL database), an automated workflow deployment 120, an application user interface (UI) 150, and application programming interfaces (APIs) 140 (which may be referred to as a “backend”). In some embodiments, one or more of the deployments is a Kubernetes deployment, which may be on the same composable/cloud platform (e.g., Purdue University's composable Geddes platform).

Embodiments of the present disclosure deploy one or more databases 130 to perform ingestion 120, user interface (UI) 150 and/or application programming interface (APIs) 140 deployments. Use of databases 130 that are popular with natural language processing (NLP) applications can have advantages due to their compatibility with text and text embedding data. Use of databases 130 that include support for GPU acceleration can also have advantages in improving performance. One example database is open source databases, such as PostgreSQL open source database.

The database 130 can be the driver for all subsequent analytic capabilities in the application and can also be used to store model results from clustering and anomaly detection for use in visualizations and queries.

In at least one embodiment the database 130 includes one or more of the following (which may be referred to as tables):
1. ticket information,
2. cluster information,
3. embedding information
4. anomaly model results,
5. forecast model results,
6. customer information, and
7. group information (e.g., information about the department or laboratory to which a customer belongs).

Some embodiments utilize an updating module (e.g., a Cron orchestrator job 120) to regularly update the database 130 and models with new input data (e.g., tickets), and in some embodiments the database 130 is continually updated. At least one advantage to regularly updating the database 130 is that the application will have continuing value for identifying emerging trends.

To perform the updating some embodiments utilize a repeating schedule module in which a script (e.g., APIs or database queries) is used to collect input data (e.g., tickets) from a ticketing system. For example, some embodiments utilize an ingestion Cron orchestrator job 120 deployed via Kubernetes that runs regularly (e.g., once each week) and begins by using a script (e.g., API calls) to scrape ticketing system reports (e.g., Jira ticketing system reports) and find tickets that have been closed since the last run of the Cron orchestrator job 120 for further processing.

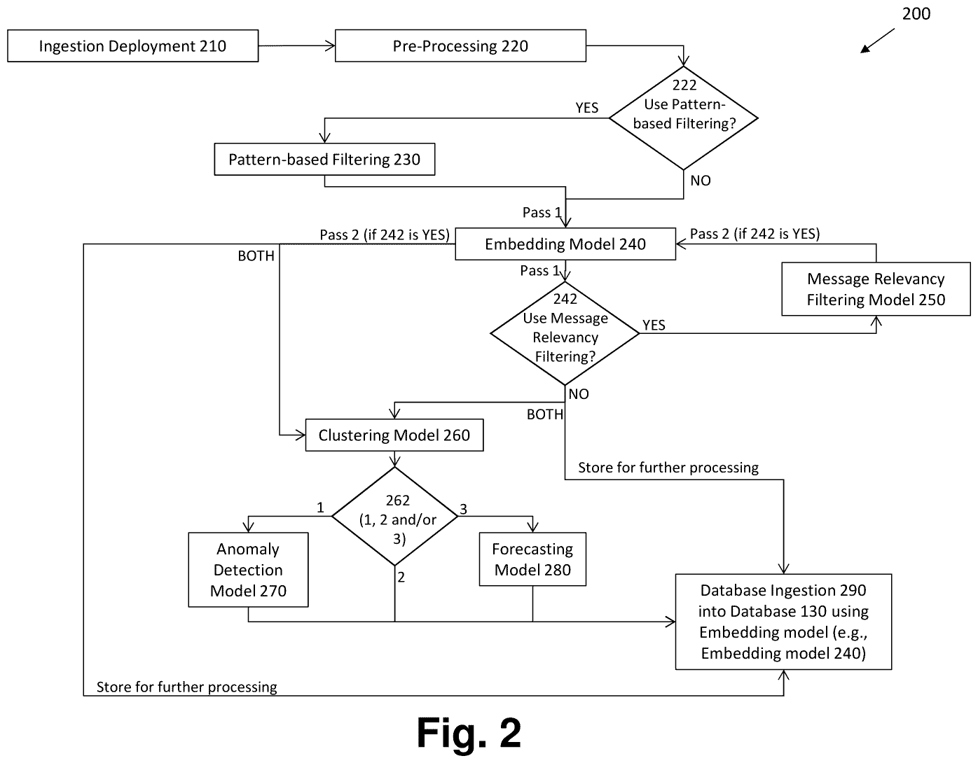

FIG. 2 is a diagram of an automated workflow system 200 (e.g., a Cron Orchestrator deployment 120 as shown in FIG. 1) that enables actionable analysis of support center help requests according to embodiments of the present disclosure.

An ingestion deployment 210 is used to run the Cron Orchestrator 120. Different ingestion modalities can be used for the ingestion deployment 210. For example, some embodiments utilize the Kubernetes open source system for the ingestion deployment 210, and in some of these embodiments the ingestion deployment 210 includes an ingestion Cron job. The ingestion deployment 210 can utilize the database 130 and may also be hosted on a composable platform, such as a community composable platform, one example being Purdue University's composable Geddes cluster or any commercial could platform such as Amazon Web Services (AWS). When utilizing such a composable platform, the deployments can utilize a database in the composable platform, and can also utilize a shared multi-pod persistent storage volume to aid in the flow of supporting data (e.g., reports and embeddings) between services.

After data ingestion via the ingestion deployment 210, pre-processing 220 may be performed. In some embodiments pre-processing 220 may occur after an update of database 130. Pre-processing 220 can include, for example, data cleaning, feature engineering and/or performing calculations to prepare derived columns for future use. In at least one embodiment implementing data cleaning during pre-processing 220, the data cleaning includes calculating derived columns and/or parsing text.

After the ingestion deployment 210 is performed (see, decision 222), some embodiments utilize pattern-based filtering 230 before implementing an embedding model 240, while other embodiments do not utilize pattern-based filtering 230 before implementing an embedding model 240. One example technique for pattern-based filtering 230 is using regular expression (regex) searching to remove auto-generated system information from the ticket messages.

After the embedding model 240 is performed, a message relevancy filtering model 250, a clustering model 260, and/or database ingestion 290 may be performed.

If message relevancy filtering 250 is utilized in the embodiment illustrated in FIG. 2 (“Yes” at decision 242), the output from the message relevancy filtering 250 (which will generally include less data than the input into the message relevancy filtering model) is run through the embedding model 240, which amounts to re-embedding of the data via a “second pass” through the embedding model 240, although the actual data making a “second pass” through the embedding model 240 is different from the data that made the “first pass” through the embedding model 240 because of having passed through the message relevancy filtering model 250. After the “second” pass through the embedding model 240, the data will be separately and simultaneously ingested into both the clustering model 260 and the database 130. The data ingested into the database 130 (via the database ingestion model 290) is stored in database 130 for further processing.

If message relevancy filtering 250 is not utilized in the embodiment illustrated in FIG. 2 (“No” at decision 242), the output from the message relevancy filtering 250 is separately and simultaneously ingested into both the clustering model 260 and the database 130. The data ingested into the database 130 (via the database ingestion model 290) is stored in database 130 for further processing.

In at least some embodiments of the present disclosure, the further processing can include using the stored copy of the results to enable and allow for more expedited delivery of insights.

The output from the clustering model 260 can be ingested by one or more of the following (see, decision 262):
1. an anomaly detection model 270,
2. a forecasting model 280, and
3. a database ingestion 290.

In embodiments utilizing an anomaly detection model 270 after the clustering model 260, database ingestion 290 will follow the anomaly detection model 270.

In embodiments utilizing a forecasting model 280 after the clustering model 260, database ingestion 290 will follow the forecasting model 280.

In at least one embodiment database ingestion 290 can include utilization of insert statements to add data to the database 130, and can also include ingestion of clustering model results and finalized embeddings.

In embodiments where both the anomaly detection model 270 and the forecasting model 280 are utilized, four sets of information will be ingested into database 130: finalized embeddings (from one or two passes through embedding model 240), clustering, anomaly detection model results, and forecast model results.

Embodiments utilizing a relevancy filter model 250 can utilize machine learning-informed preprocessing capabilities that can support and enhance downstream performance of a semantic search feature, e.g., the semantic search features described herein. Embodiments of this relevancy filter model 250 (which is typically run during the new data ingestion) were developed by the inventor based on insights obtained from the Exploratory Data Analysis (EDA), where the inventor realized that many tickets included messages that were not pertinent to the technical topic at hand (e.g., pleasantries, checking on the status, etc.). See, e.g., Table 2 depicting sample messages divided into relevant and irrelevant category types. Advantages may be realized in some embodiments when the message relevancy filtering model ingest messages that are individually embedded.

Tickets typically contain multiple messages prior to the messages being closed, meaning that the concatenated text for each ticket tends to be lengthy. In one example, tickets contained an average of 4.7 messages prior to the ticket being closed. These multiple messages pose a challenge to using NLP techniques. Standard text embedding techniques truncate text after a certain number of tokens (e.g., after 512 tokens) and/or use pooling mechanisms (i.e., down-sampling, often through averaging), so including irrelevant text can have the effect of diluting the important content in embeddings, thereby degrading downstream performance.

To mitigate this issue, embodiments of the present disclosure utilize an initial classifier that filters out irrelevant messages and decreases overall ticket length. Embodiments of this binary classification type of relevancy filter model are built using a supervised learning approach. In one example embodiment the classification model is built by fine-tuning a pre-trained model, such as a pre-trained model based on Bidirectional Encoder Representations from Transformers (BERT), which include beneficial aspects such as being well-validated, documented, and integrated into various helper tools, e.g., HuggingFace, which can assist in expediting development.

At least one embodiment utilizes the DistilBERT pre-trained model, which has advantages of being a fast and lightweight alternative to other models based on Bidirectional Encoder Representations from Transformers (BERT).

The relevancy filter model 250 may then be used to perform inference and predict the relevancy of individual messages in each ticket. Those messages predicted to be irrelevant by the relevancy filter model 250 are removed from the full ticket correspondence prior to re-embedding the relevant ticket text for use in the semantic search features described herein.

To develop training data for the relevancy filtering, a plurality of messages (e.g., several thousand messages) may be manually classified as being either relevant or irrelevant. See, e.g., Table 2. In one example embodiment an open-source text annotation tool (e.g., one utilizing Doccano) is used. To facilitate the manual classification, embodiments utilize Doccano instance, which may be deployed via Kubernetes.

Prior to training the relevancy filter model 250, annotated data may be reviewed for accuracy to facilitate evaluation of the relevancy filter model 250. In one example the relevancy filter model 250 converged to 95% accuracy on the test set after approximately 17 training epochs and was containerized and deployed as part of the cron orchestrator process in at least one embodiment.

Although a relevancy filter model may utilize manual annotating for training, once developed the relevancy filter model may be utilized with other ticket datasets with little to no further fine-tuning.

TABLE 2
Example of message relevancy ratings

| Message Type | Message |
|---|---|
| Irrelevant | “Hi XXX, Changing command to “imp” |
| | worked. Thank you. You can close this ticket. |
| | Regards, XXX” |
| Relevant | “XXX, You may need to specify which one to |
| | use within the code as TensorFlow/Keras can |
| | utilize both the GPU or CPU on a machine . . .” |

Embodiments of the present disclosure utilize temporal topic modelling to calculate how the prevalent themes in a set of documents change over time. In one example a BERTopic model is used based on embeddings generated via embedding model 240. In some embodiments the temporal topic model is run on ticket title text to identify these prevalent themes. The temporal topic model may also be used to group each ticket into one of the identified clusters.

Embodiments using embeddings of ticket titles (as opposed to message text) can have advantages when used for clustering since ticket titles tend to provide a built-in summary of the customer's primary concern. This approach has the ability to identify many more useful cluster names. In at least one example, using ticket text (instead of ticket titles) led to over-indexing on general domain-specific words (e.g., “Purdue” or “RCAC”) and staff names, which, while potentially a proxy for ticket topic, do not provide as accurate of a picture.

Prior to running the temporal topic model, standard stopwords may also be removed in pre-processing 220 in order to prevent words like prepositions from showing up in cluster names. Embodiments that remove such words from messages tend to improve separation between clusters. In one example, after setting the minimum cluster size to 75 tickets, 63 clusters were identified from more than 20,000 tickets, though clusters tend to vary over time with the ingestion of new tickets.

Prior to running the temporal topic model, standard stopwords may also be removed in order to prevent words like prepositions from showing up in cluster names. Embodiments that remove such words from messages tend to improve separation between clusters. In one example, after setting the minimum cluster size to 75 tickets, 63 clusters were identified from more than 20,000 tickets, though clusters tend to vary over time with the ingestion of new tickets.

Due to various factors, one being a minimum size criterion that may be utilized, a portion of tickets may not fall into any specific cluster. In this situation this portion of tickets may be placed into a generic category. Although there are tradeoffs when utilizing a generic category, these tradeoffs can be beneficial since creating too many clusters (which tends to occur when not utilizing a generic cluster) tends to decrease the usability of the model for identifying insights. While use of a generic category may result in a slight delay in capturing new topics (especially when the clustering model is re-run on a fairly long period, such as being re-run on a weekly cadence), any significant emerging topics will eventually be identified.

To evaluate the results of clustering, representative words for each cluster (as generated by the temporal topic model), as well as sampling tickets by cluster, can be used.

The clusters can tend to range from very broad conceptual topics (e.g., submitting jobs to a computing system) to very specific concerns. For example, questions about purchasing storage in centralized research data storage system (one example being the Data Depot service at Purdue University) will frequently be in a different cluster than questions about accessing the centralized data storage system or giving customers permissions to access the centralized data storage system. Nevertheless, all clusters were judged by the inventor's experience with customer requests to be significant drivers of ticket requests. Table 1 depicts the representative words identified for an example subset of current clusters. Many of these representative words refer to specific technologies and services that may be offered to customers, showing that the example model effectively captures domain-specific information.

TABLE 1

| Representative Words | Comments |
|---|---|
| [gilbreth, gpu, cuda, tensorflow] | GPU and machine learning jobs |
| [bell, cluster, gateway, jobs] | Using the Bell cluster |
| [fortress, group, files, transfer] | Transferring files |
| [job, submission, jobs, submitting] | Submitting and running jobs |
| [depot, permissions, folder, data] | Data storage and access |
| [github, enterprise, git, repository] | Using GitHub |

Anomaly detection models 270 may be refit with the updated dataset, which can help clusters to remain valid over time and that ticket trends and anomalies are being effectively captured.

While visual inspection of ticket trends can provide valuable information to the staff of a computer resource and service center (CRSC), such as information about potential hardware or system issues, the quantity of data and variation in daily ticket volume can make it difficult to quickly differentiate between standard and anomalous events. Embodiments of the present disclosure facilitate users (e.g., CRSC support staff) understanding the normal range and frequency as well as anomalous events can, which can be beneficial from a system support perspective by providing information facilitating optimization of staffing and subject matter expertise availability.

Although certain existing data anomaly detection algorithms (e.g., the Isolation Forest Algorithm (IFA)) may be utilized, there are drawbacks to using these existing algorithms. For example, applying existing data anomaly detection algorithms (e.g., the IFA) on a single feature (e.g., the number of tickets) produces results that are essentially equivalent to identifying anomalies from the tails of a probability distribution. While embodiments utilizing such an approach can be successful in classifying extremely high or low observations as anomalies, these embodiments have difficulties capturing unusual observations which appear closer to the mean when taken at face value, but may still be outliers in their respective neighborhood. As such, embodiments of the present disclosure take into account seasonality across different frequencies to uncover “unusual” observations.

Time-series forecasting methods such as Seasonal Autoregressive Integrated Moving Average (SARIMA) are intended to explain the presence of a peak or a trough, and that presence is “learned” in order to generate coefficients. However, the inventor of the present disclosure realized that forcing such a model to identify anomalies instead of learning them can turn into an unnecessarily complex task.

Therefore, instead of taking a time-series analysis approach to determining seasonalities across frequencies (e.g., weekly, monthly, daily, yearly), embodiments of the present disclosure use a feature engineering approach to generate scores (e.g., four total scores, one based on week, one based on month, one based on day, and one based on year) for each observation. In an example, each set of scores (e.g., sets based on week, month, day, year) were treated as features that explain the behavior of the observation. Along with absorbing information from the neighboring time-points, these scores can extract predictive power from similar seasons across different time-frequencies (this month last year, this week last month, etc.). This can be equivalent to building an unsupervised SARIMA model with many seasons, instead of only one.

In at least one embodiment the generated scores are normalizations (e.g., simple normalizations, such as z-scores) of the observation, with each normalization using different statistical means and standard deviations. In at least one embodiment, the following statistical means and standard deviations are used to arrive at the four different normalized values for a single observation:
Day Score: The statistical mean and standard deviation of the number of tickets received on a particular day of the week throughout the time period (e.g., Mondays are compared to all other Mondays in the timeframe).
Week Score: The statistical mean and standard deviation of the number of tickets received in a particular week number of any month throughout the time period.
Month Score: The statistical mean and standard deviation of the number of tickets received in a particular month of any year throughout the time-period.
Year Score: The statistical mean and standard deviation of the number of tickets received in that year.

These four features can then be fed into the anomaly detection algorithms (e.g., an IFA) to capture the true anomalies. For example, suppose it is expected based on history that 0 (zero) tickets are submitted on Sundays, but on one Sunday 5 tickets are submitted. That observation will be detected as an anomaly based on the elevated day score.

The anomaly detection algorithm (e.g., IFA) can allot a score based on the four score features. For example, in at least one embodiment the anomaly detection algorithm allots a score between negative 1 (−1) and positive 1 (+1) to each data point, with scores closer to −1 indicating irregularity and scores closer to +1 indicating regularity.

In some embodiments, border points are also identified instead of classifying only whether an observation is anomalous. This is achieved by classifying observations with anomaly scores in a sub-range of the total range, such as classifying observations between −0.05 and 0 (zero) as border points. In some embodiments the plot on the user dashboard is structured not only to showcase anomalies aggregated by clusters, but also to provide the reason a particular observation was found to be anomalous, such as by identifying which of the four features contributed most to the classification. This implementation can be beneficial in improving the transparency and utility of the system for end users.

Once information from the clustering model 260 is ingested into the forecasting model 280, the forecasting model 280 generates output that predicts, for example, how many tickets will be received of a certain topic in a time frame, which can be beneficial in, for example, scheduling or hiring agents with different abilities during times when their abilities are expected to be needed. To do this, the forecasting model is run on top of the clustering results. Embodiments of the forecasting model 280 uses a curve-fitting algorithm, such as a simple exponential smoothing model, to forecast upcoming ticket load. Still other embodiments use other forecasting models, such as ARMA (autoregressive moving average model or ARIMA-based approaches.

An embedding model 240 is used to generate embeddings (vector representations of the data created using, e.g., deep learning techniques) of the ticket data, for example, to encode the meaning of what is in the text of the support ticket data into numeric vectors. A single embedding model 240 can be used one or more times. The embedding model 240 can be used to embed ticket data text and/or tickets titles, and the final embeddings (e.g., the embeddings that occur after the text has undergone pattern-based and/or relevancy filtering) are ingested into database 130 in step 290. In some embodiments the embedding model 240 is run more than once before the results are ingested into the database 130. For example, in embodiments utilizing message relevancy filtering 250, the initial embeddings (e.g., the embeddings done prior to message relevancy filtering 250) are not ingested into database 130-only the final embeddings are ingested into database 130.

Within system 200 the embedding model 240 may be run one or more times prior to database ingestion. The embedding model 240 may also be run when a user/agent enters a search term into search functionality, such as the semantic search (e.g., the query is embedded then compared against the embedding data in the database).

Once data (including their embeddings) are ingested into database 130, embeddings (e.g., such as semantic searching) may be generated for the ingested data. Embodiments may then include search functionality (e.g., semantic searching functionality) related to the embeddings, and this search functionality can be used as an alternative to any search capabilities that may be built directly into a computing center's current system (e.g., a ticketing system, such as the RCAC's Footprints (FP) ticketing system, which may enable only keyword-based searching). The semantic search may be enabled by ingestion 290 of embedding data into a vector database (e.g., PGVector or Chroma).

A common drawback to the search functionality in many computing centers is that the computing center's search tool typically utilizes only keyword-based searching, which can make it difficult to search for similar tickets that do not use the exact same wording. Another drawback is that the query results from a computing center's built-in search capabilities can dramatically degrade as query length increases. These factors can make it difficult for computing center agents to identify similar issues and resolutions among archival tickets.

To address at least these issues, embodiments of the present disclosure improve performance by implementing an embedding-based asymmetric semantic search approach. Sample results for an example embodiment are depicted in Table 3.

Upon ingestion of data to the database, embodiments of the present disclose create embeddings for all of the filtered customer messages. When a user (e.g., computing center agent) enters a query into the user interface (UI), the query is also embedded and tickets with embeddings closest to the embedded query (which may be based on dot-product scoring) are returned in accordance with how the pre-trained model was tuned.

In some embodiments the ticket text are used for semantic search embeddings while embeddings of ticket titles are used in the clustering model. While titles often provide a good summary of the ticket, by their nature titles do not include many details, which can be important to finding tickets that refer to very specific issues or topics (e.g., “Error with conda module” vs. “I am experiencing an issue using the conda module where commands hang and never complete, and when I force quit it gives an error about the conda.config.”).

After relevancy filtering 230, an embedding model 240 embeddings for both the queries and ticket text may be created using a file/document embedding model. One example is the SentenceTransformer implementation of the DistilBERT architecture that has been pre-trained on the Microsoft Machine Reading Comprehension (MS MARCO) dataset corpus and tuned for dot-product similarity scoring. Embodiments using a dot-product-tuned model has advantages in that these are better at retrieving longer documents. SentenceTransformer is based on Sentence-BERT, which proposes a solution to the issue of creating semantically meaningful sentence embeddings, as opposed to the word embeddings for which traditional BERT is best suited. The Microsoft Machine Reading Comprehension (MS MARCO) dataset corpus was created from customer queries from the Bing search engine, making it appropriate for question-answering and semantic search tasks.

In addition to the semantic search capability, additional features may be included to allow users to search by other specific fields as well (e.g., the username of the customer submitter) or filter based on fields (e.g., the identified cluster).

TABLE 3
Sample Search Results

| | Results from | Top 3 Semantic Search | |
|---|---|---|---|
| | built-in search | Results using semantic search | |
| | capabilities in | feature of an embodiment | |
| | computing center's | of the present disclosure | |
| Query | ticketing system | (only ticket titles shown) | Comments |
| “Arcgis | None | ArcGIS Server License Question | Query refers |
| libraries” | | Ask for Single Use License | to using |
| | | ArcGIS Pro Software Issues | ArcGIS |
| “Install | None | Dataworkbench R Studio Package | Query refers |
| udunits” | | installation issue | to R package |
| | | Install R packages on Gilbreth | udunits2 |
| | | Adding udunits2 to the clusters? | |

An application (e.g., a Flask app) containing application programming interfaces (APIs) for database 130 queries and calculations/processing for display on the user interface (UI) 140 can be used as an application backend. The application programming interfaces (APIs) 140 can populate the visualizations and perform search functionalities.

In some embodiments the application is designed such that future domains for which the application is deployed require only revising the ingestion 210 of input data 115 and pre-processing 220 to configure the data 115 into an acceptable format for downstream analysis. Other services can also be containerized and can be portable for use in other computing centers.

An application user interface (UI) 150 can be utilized to assist users (e.g., computing center agents) in visualizing and interacting with the analytic functionalities. In some embodiments the user interface (UI) 150 is developed using open source programming frameworks, e.g., using React, which can provide a robust base from which to integrate the UI into other existing computer resource and service center (CRSC) systems). Further embodiments use scripting languages such as Java script to build out the application (e.g., React-based web applications) which may be more robust and/or add functionality to integrate the UI 150 into other existing computer resource and service center (CRSC) systems. To facilitate ticket data privacy, the application can be secured behind a login page that, for example, allows only computer resource and service center (CRSC) agents authority to create accounts.

Once users have logged in, a ticket dashboard and/or a search page can be available for selection. Users can also select the underlying data they want utilized for viewing on the dashboard or for searching, such as via a dropdown menu enumerating the database choices.

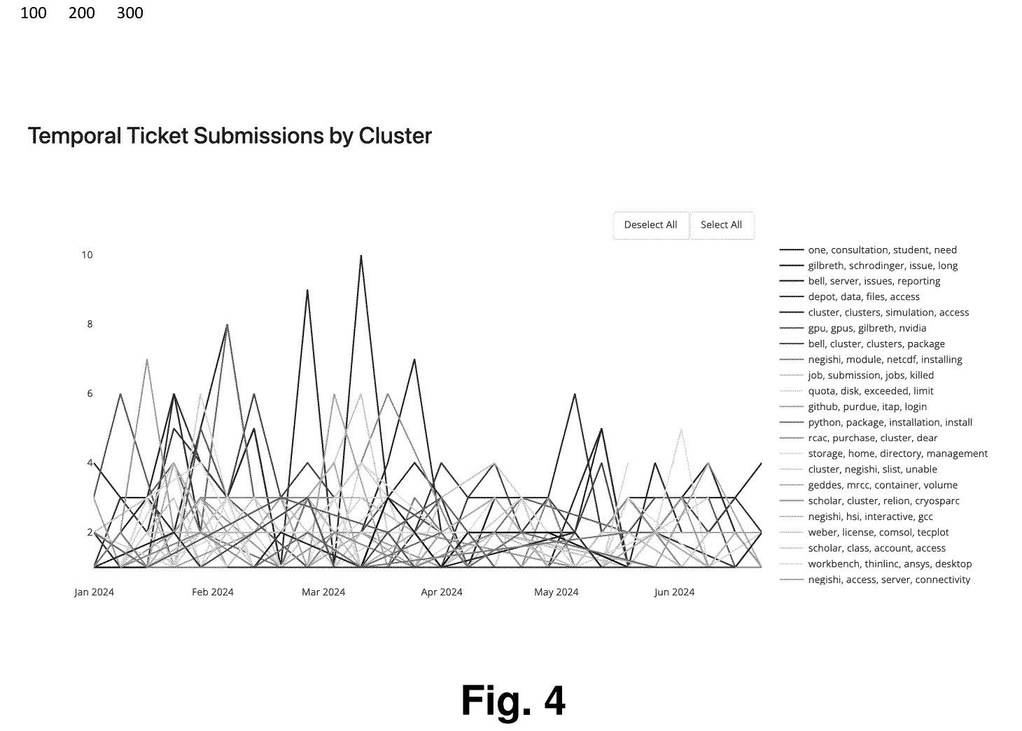

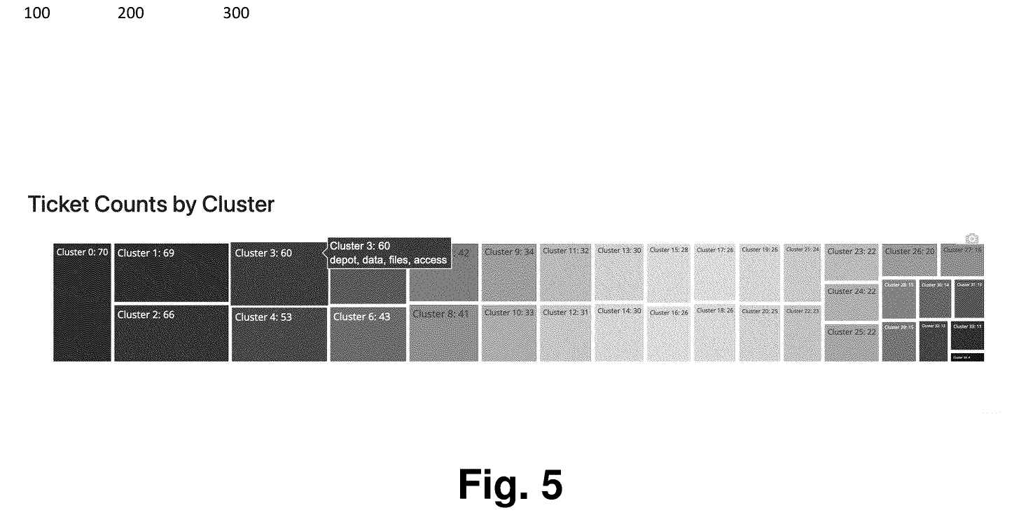

The ticket dashboard can dynamically calculate and display a variety of metrics and analyses for any user-entered date range. These metrics can include both cluster-informed and general calculations and visualizations. Some of the metrics displayed to a user may be similar to metrics that are commonly used in other systems to make the system 100 a single source of knowledge about support requests. FIG. 3 shows a ticket dashboard displaying metrics and clustering according to at least one embodiment. Metrics can denote the metric for the selected date range as compared to over all time. A graph of clusters over time can be displayed to show ticket topic trends. This graph, as well as all others, can be interactive and allow users to zoom in/out on sections or to isolate and visualize only specific clusters. FIG. 4 is an example of a display for visualizing overall ticket volumes by cluster over a time period as well as indicators regarding ticket resolution. These indicators can include customers and groups of customers who have submitted the most tickets and the clusters with tickets with, for example, the longest average open time (which can allow identification of, for example, difficult types of issues and/or customers (and/or customer groups) who may benefit from additional training). FIG. 5 shows an example of cluster-wise analysis and metrics including a cluster-wise anomaly detection model.

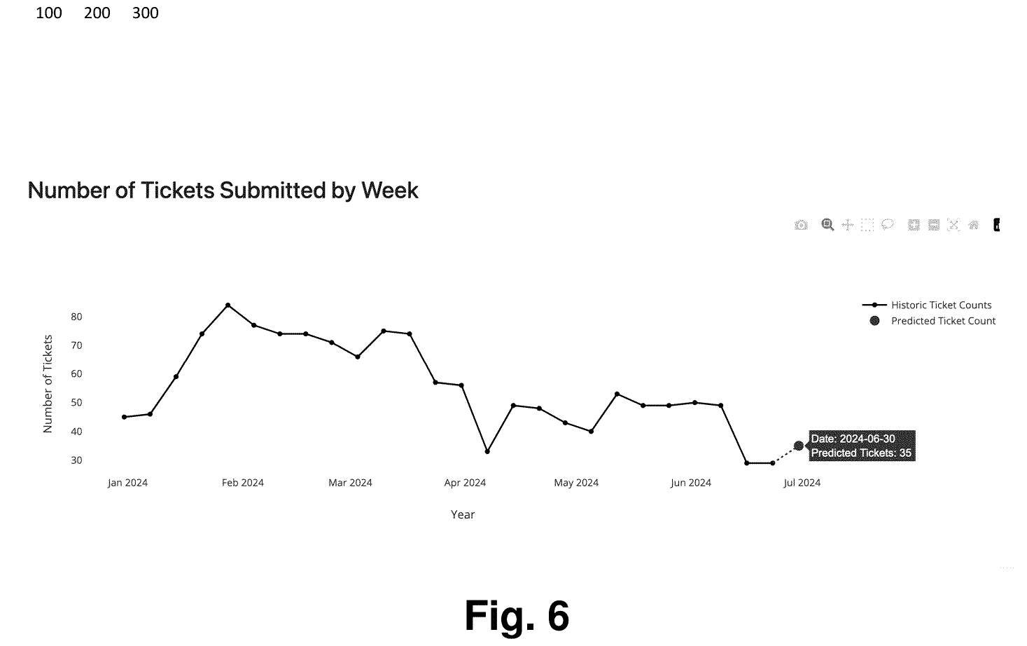

The search page can allow a user to find relevant tickets by including, for example, a semantic search that identifies the most similar tickets to a query based on text embeddings and/or general query filtering features. The general query filtering features can include functionality for searching within a specific date range or based on the identified cluster. Users can optionally view the ticket messages for any of these results, as well as overall ticket metadata (e.g., when the ticket was submitted and how long it was open) FIG. 6 shows an example of a display showing the number of weekly tickets submitted and a prediction of the number of tickets that will be submitted in the next week.

While unsupervised models such as those being used in system 100 are notoriously difficult to validate quantitatively because, e.g., there is no set ground truth, unsupervised models are what enable the system 100 to provide ongoing and interactive analysis. In place of traditional metrics like those typically associated with supervised learning, extensive testing and manual qualitative assessments were done to validate analytic design choices and results with domain expertise and specific computer resource and service center (CRSC) knowledge. In an example, an HPC hardware cluster identified by one implementation of system 100 as having the most tickets in a particular year corresponded to an HPC hardware cluster that experienced critical hardware issues in the same year resulting in significantly degraded performance.

As another example, in a short time after deploying one example embodiment of system 100 (namely TicketHub at Purdue University), system 100 contributed to agents at the computer resource and service center (CRSC) indicating there was a better understanding of the tickets received. While statistical analyses may be easy to run, getting context into the types of questions was not previously possible at the computer resource and service center (CRSC). Using TicketHub for this purpose quickly revealed, for example, that had been a recent uptick (both visibly and as detected by the anomaly detection model) in questions relating to GPUs, machine learning, and a particular GPU hardware cluster. This resulted in timely prioritization and creation of new GPU-accelerated machine learning training. The semantic search feature has also contributed to finding ticket information more quickly as reported by agents. Beyond allowing for detection and analysis of trends, TicketHub has also provided additional unexpected benefits as a backup copy of archival ticket information, which is particularly pertinent to retaining knowledge when switching ticketing systems.

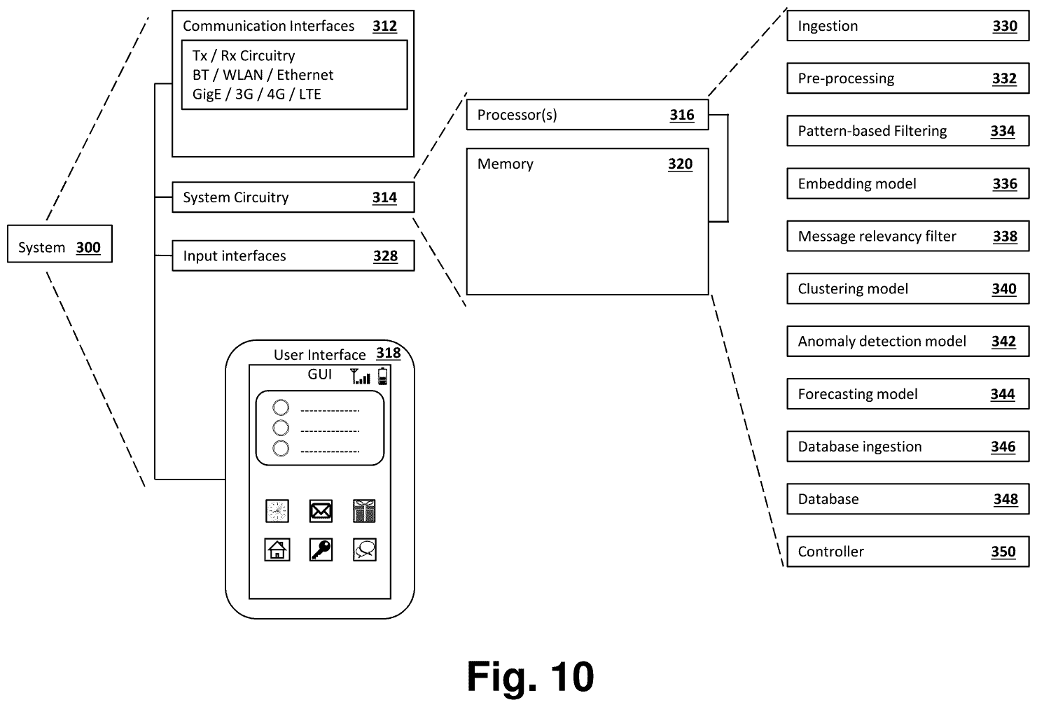

FIG. 10 illustrates a system 300, such as a system for enabling actionable analysis of support requests, according to embodiments of the present disclosure. The system 300 may be used to implement the procedures and methods disclosed herein and may include one or more communication interfaces 312, one or more input interfaces 328 and/or system circuitry 314. The system circuitry 314 may include one or more processors 316. Alternatively or in addition, the system circuitry 314 may include one or more memory units 320.

The one or more processors 316 may be in communication with the one or more memory units 320. In some examples, the one or more processors 316 may also be in communication with additional elements, such as the one or more communication interfaces 312, the one or more input interfaces 328, and/or the one or more user interfaces 318. Examples of the one or more processors 316 may include one or more of the following: general processors, central processing units, logical CPUs/arrays, microcontrollers, servers, application specific integrated circuits (ASIC), digital signal processors, field programmable gate arrays (FPGA), graphics processing units (GPU), and/or digital circuits, analog circuits, or some combinations thereof.

The one or more processors 316 may be one or more devices operable to execute logic. The logic may include computer executable instructions or computer code stored in the one or more memory units 320 or in other memory that when executed by the one or more processors 316, cause the one or more processors 316 to perform the operations of (or for) one or more ingestion deployments 330, one or more pre-processing deployments 332, one or more pattern-based filtering deployments 334, one or more embedding model deployments 336, one or more message relevancy filtering deployments 338, one or more clustering model deployments 340, one or more anomaly detection model deployments 342, one or more forecasting model deployments 344, one or more database ingestion deployments 346, one or more database deployments 348, and/or one or more controllers 350. The computer code may include instructions executable with the one or more processors 316.

The one or more memory units 320 may be any device(s) for storing and retrieving data or any combination thereof. The one or more memory units 320 may include non-volatile and/or volatile memory, such as a random access memory (RAM), read-only memory (ROM), erasable programmable read-only memory (EPROM) and/or flash memory. Alternatively or in addition, the one or more memory units 320 may include one or more optical drives, magnetic (e.g., “hard”) drives, solid-state drives or any other form of data storage device. The one or more memory units 320 may include at least one of the one or more ingestion deployments 330, the one or more pre-processing deployments 332, the one or more pattern-based filtering deployments 334, the one or more embedding model deployments 336, the one or more message relevancy filtering deployments 338, the one or more clustering model deployments 340, the one or more anomaly detection model deployments 342, the one or more forecasting model deployments 344, one or more database ingestion deployments 346, the one or more database deployments 348, and/or the one or more controllers 350. Alternatively or in addition, the memory may include any other component or subcomponent of the system 300 described herein.

The one or more user interfaces 318 may include any interface for displaying graphical information. The system circuitry 314 and/or the one or more communications interfaces 312 may communicate signals or commands to the one or more user interfaces 318 that may cause one or more user interfaces to display graphical information. Alternatively or in addition, the one or more user interfaces 318 may be remote to the system 300 and/or the system circuitry 314. The one or more communication interfaces 182 may communicate instructions, such as HTML, to the one or more user interfaces 318 to cause the one or more user interfaces 318 to display, compile, and/or render information content. In some examples, the content displayed by the one or more user interfaces 318 may be interactive or responsive to user input. For example, the one or more user interfaces 318 may communicate signals, messages, and/or information back to the one or more communications interface 312 and/or to the system circuitry 314.

The system 300 may be implemented in many ways. In some examples, the system 300 may be implemented with one or more logical components. For example, the one or more logical components of the system 300 may be hardware or a combination of hardware and software. The one or more logical components may include the one or more ingestion deployments 330, the one or more pre-processing deployments 332, the one or more pattern-based filtering deployments 334, the one or more embedding model deployments 336, the one or more message relevancy filtering deployments 338, the one or more clustering model deployments 340, the one or more anomaly detection model deployments 342, the one or more forecasting model deployments 344, one or more database ingestion deployments 346, the system 300 and/or any component or subcomponent of the system 300. In some examples, each of the one or more logic components may include one or more application specific integrated circuits (ASIC), one or more Field Programmable Gate Arrays (FPGA), one or more digital logic circuits, one or more analog circuits, one or more combinations of discrete circuits, gates, or any other type of hardware or combination thereof. Alternatively or in addition, each component may include memory hardware, such as a portion of the one or more memory units 320, for example, that comprise instructions executable with the one or more processors 316 and/or one or more other processors to implement one or more of the features of the logical components. When any one of the logical components includes a portion of the memory that comprises instructions executable with the one or more processors 316, the component may or may not include the one or more processors 316. In some examples, each logical component may just be the portion of the one or more memory units 320 or other physical memory that comprises instructions executable with the one or more processors 316, or other processor(s), to implement the features of the corresponding component without the component including any other hardware. Because each component can include at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, and/or read from one or more types of computer readable storage media. Examples of the computer readable storage medium may include one or more of the following: hard disks, floppy disks, CD-ROM units, flash drives, caches, volatile memory units, non-volatile memory units, RAM units, flash memory units, and/or any other type of computer readable storage medium or storage media. The computer readable storage medium may include one or more of any type of non-transitory computer readable medium, such as one or more CD-ROMs, volatile memories, non-volatile memories, ROM units, RAM units, and/or other suitable storage devices.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may be implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed herein may be provided on computer readable storage media. The functions, acts or tasks illustrated in the figures or described herein may be executed in response to one or more sets of logic or instructions stored in or on computer readable media. The functions, acts or tasks are independent of the particular type of instruction sets, storage media, processors or processing strategies and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other types of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

Moreover, one or more of the features and/or items depicted in FIG. 10 may be implemented utilizing cloud computing, resulting in the hardware being in different physical locations and communicating via a network, such as the internet, that allows hardware that is located remotely to other hardware to nevertheless communicate with one another.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

Use of system 100 has particular applicability in the realm of reporting and monitoring and has been known to significantly ameliorate two main problems identified in customer support groups. First, with larger computing centers and specialized groups, it can be difficult to capture a complete picture of the current state of help tickets beyond basic statistics. But, doing so is instrumental in making meaningful data-driven decisions, such as how to prioritize creating training sessions or guides and even in determining what kinds of expertise are needed when searching for new agents. Second, as new agents join the center, there is often a steep learning curve to learn the intricacies of the clusters, and it is not a scalable nor maintainable approach to simply rely on the knowledge of more tenured agents. Embodiments of system 100 advance a solution by significantly improving search capabilities from archival tickets.

Help tickets are fundamentally a lagging indicator as data can only be collected and used for analysis once the ticket has been closed, which can average approximately two weeks. However, while embodiments of this application may not provide real-time analytics due to the lag time, it is a useful tool to assist support agents in identifying similar prior solutions to issues and capturing larger trends, and the TicketHub implementation has led to the identification of training needs as well as having provided an improved way in which to search the knowledge base for actionable information.

Reference systems that may be used herein can refer generally to various directions (e.g., upper, lower, forward and rearward), which are merely offered to assist the reader in understanding the various embodiments of the disclosure and are not to be interpreted as limiting.

To clarify the use of and to hereby provide notice to the public, the phrases “at least one of A, B, . . . and N” or “at least one of A, B, . . . . N, or combinations thereof” or “A, B, . . . and/or N” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. As one example, “A, B and/or C” indicates that all of the following are contemplated: “A alone,” “B alone,” “C alone,” “A and B together,” “A and C together,” “B and C together,” and “A, B and C together.” If the order of the items matters, then the term “and/or” combines items that can be taken separately or together in any order. For example, “A, B and/or C” indicates that all of the following are contemplated: “A alone,” “B alone,” “C alone,” “A and B together,” “B and A together,” “A and C together,” “C and A together,” “B and C together,” “C and B together,” “A, B and C together,” “A, C and B together,” “B, A and C together,” “B, C and A together,” “C, A and B together,” and “C, B and A together.”

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

### Element Numbering

Table 4 includes element numbers and at least one word used to describe the element and/or feature represented by the element number. However, none of the embodiments disclosed herein are limited to these descriptions. Other words may be used in the description or claims to describe a similar member and/or feature, and these element numbers can be described by other words that would be understood by a person of ordinary skill reading and reviewing this disclosure in its entirety.

TABLE 4

| | |
|---|---|
| 100 | System (e.g., for enabling actionable analysis of support requests) |
| 110 | ticket software |
| 115 | input data |
| 120 | automated workflow (e.g., cron orchestrator) |
| 130 | database |
| 140 | application programming interfaces (APIs) |
| 150 | user interface (UI) |
| 182 | communication interface |
| 190 | user |
| 200 | automated workflow (e.g., cron orchestrator) |
| 210 | ingestion deployment |
| 220 | pre-processing |
| 222 | decision |
| 230 | pattern-based filtering |
| 240 | embedding |
| 242 | decision |
| 250 | message relevancy filtering |
| 260 | clustering model |
| 262 | decision |
| 270 | anomaly detection |
| 280 | forecasting |
| 290 | database ingestion |
| 300 | system (e.g., for enabling actionable analysis of support requests) |
| 312 | communication interface |
| 314 | system circuitry |
| 316 | processor |
| 318 | user interface |
| 320 | memory unit |
| 328 | input interface |
| 330 | ingestion deployment |
| 332 | pre-processing deployment |
| 334 | filtering deployment |
| 336 | embedding model deployment |
| 338 | filtering deployment |
| 340 | clustering model |
| 342 | anomaly detection model deployment |
| 344 | forecasting model deployment |
| 346 | database ingestion deployment |
| 348 | database deployment |
| 350 | controller |

What is claimed is:

1. A system configured to assist users in evaluating support request records, comprising:
one or more processors to:
receive into a clustering model output from an embedding model, the information from the embedding model including information related to a plurality of support request records;
generate with the clustering model a clustering model output, wherein when generating the clustering model output the clustering model
maps vectors from each support request record in the output from the embedding model into a vector space,
evaluates the vectors for similarities,
locates separations between groups of similarly mapped vectors,
defines clusters based on the separations, and
maps each support request record to a single cluster;
receive the clustering model output into at least one of
an anomaly detection model, and
a forecasting model,
wherein
when the anomaly detection model receives the clustering model output, the anomaly detection model generates an anomaly detection model output based, at least in part, on the clustering model output, and when generating the anomaly detection model output the anomaly detection model
evaluates one or more metadata elements of support requests associated with a cluster,
derives scores from the one or more metadata elements based on the number of occurrences of support requests with each of the one or more metadata elements during one or more preset time periods,
evaluates the scores to detect time periods with anomalous scores, and
maps each support request to indicate that the support request occurred during an anomalous time period or during a non-anomalous time period based on the scores,
when the forecasting model receives the clustering model output, the forecasting model generates a forecasting model output based, at least in part, on the clustering model output, and when generating the forecasting model output the forecasting model
evaluates one or more clusters of the clustering model output,
maps one or more clusters to one or more time periods,
creates a mathematical function for each cluster to describe the trend of that cluster during the one or more time periods, and
extrapolates the mathematical function to future time periods;
receive into a database ingestion model the clustering model output; and
receive into the database ingestion model the at least one of the anomaly detection model output and the forecasting model output;
wherein the information received into the database ingestion model is used to provide information about the support request records to a user.

2. The system of claim 1, wherein at least one of the clusters into which support request records are mapped is a generic cluster for support requests that do not fit into one of the specified clusters.

3. The system of claim 1, wherein the scores include day score, week score, month score and year score normalizations.

4. The system of claim 1, wherein when generating the anomaly detection model output the anomaly detection model evaluates the scores to detect border points.

5. The system of claim 1, wherein the anomaly detection model evaluates scores on a cluster by cluster basis.

6. The system of claim 1, wherein the anomaly detection model outputs support request data wherein captured support requests are mapped to a classification as anomalous, borderline or normal.

7. The system of claim 1, wherein the one or more metadata elements include time.

8. A system configured to assist users in evaluating support request records, comprising:
one or more processors to:
receive into a pre-processing model output from an ingestion deployment, the information from the ingestion deployment including information related support request records;
generate with the pre-processing model a pre-processing model output, wherein when generating the pre-processing model output the pre-processing model
preparing data fields for further use including deriving additional metadata based on calculations utilizing raw metadata
receive the pre-processing model output into at least one of
a pattern-based filtering model, and
an embedding model,
wherein
when the pattern-based filtering model receives the pre-processing model output, the pattern-based filtering model generates pattern-based filtering model output and delivers the pattern-based filtering model output to the embedding model, and when generating the pattern-based filtering model output the pattern-based filtering model
recognizes patterns in the support request record data related to extraneous system information, wherein the extraneous information includes system information that is duplicative of metadata or irrelevant to the content of the support request,
identifies irrelevant or extraneous text based on the recognized patterns, and
removes from the data set text identified as being irrelevant or extraneous, and
wherein
the embedding model receives pre-processing model output or pattern-based filtering output, and when the embedding model receives the pre-processing model output or the pattern-based filtering output, the embedding model generates a first embedding model output based, at least in part, on the received pre-processing model output or pattern-based filtering output, and when generating the first embedding model output the embedding model
assigns vectors to the text elements of the support request data representing the content of the text elements; and
receive the first embedding model output into
a message relevancy filtering model, or
a database ingestion model,
wherein
when the message relevancy filtering model receives the first embedding model output, the message relevancy filtering model generates message relevancy filtering model output and delivers the message relevancy filtering model output back to the embedding model, and when generating the message relevancy filtering model output the message relevancy filtering model
categorizes each individual correspondence of each support request record as being either relevant or irrelevant to the technical topic addressed in the support request record,
removes from the text elements those individual correspondences identified as being irrelevant, and
delivers the message relevancy filtering model output to the embedding model, and
when the embedding model receives message relevancy filtering model output, the embedding model generates a second embedding model output based, at least in part, on the received message relevancy filtering model output, and when generating the second embedding model output the embedding model
assigns vectors to the text elements of the support request data representing the content of the text elements, and
delivers the second embedding model output to the database ingestion model,
wherein the information received into the database ingestion model from the second embedding model output is used to provide information about the support request records to a user; and
when the database ingestion model receives the first embedding model output, the information received into the database ingestion model from the first embedding model output is used to provide information about the support request records to a user.

9. A system configured to assist users in evaluating support request records, comprising:
one or more processors to:
perform the actions identified in claim 8; and
perform the action identified in claim 1.
